(19) United States
(12) Patent Application Publication
(10) Pub. No.: US 2006/0067501 A1
(43) Pub. Date: Mar. 30, 2006

(54) Method and apparatus for a do not disturb telephone system

(75) Inventor: Kathy Goode Piatt, Cedar Park, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 10/948,869

(22) Filed: Sep. 24, 2004

(51) Int. Cl. H04M 3/42

(52) U.S. Cl. 379/210.02; 379/211.02

(57) ABSTRACT

The present invention provides a Do-Not-Disturb device interposed between a telephone line providing an incoming telephone signal and a telephone for which the incoming telephone signal is intended. When the DND device is active the incoming telephone signal is sent to voicemail, an answering machine, a call forwarding number or the telephone. When sent to the telephone the telephone does not ring when the DND device is active. The DND device being active may cause the telephone to appear busy. The DND device when active may set a voicemail or call forwarding service to take calls prior to ring the telephone by setting the ring count to zero at the voicemail or call forwarding service.

### BACKGROUND OF THE INVENTION

1. Field of the Invention

The present invention relates in general to telecommunications and specifically to a call telephone device that enables a user to ignore incoming calls during selected time periods without being disturbed by a ringing telephone.

2. Background Information

In recent years a do-not-disturb service has been commonly offered in PBX systems and has been proposed for central offices equipped with the more modern stored program control (SPC) electronic switches. Such switches are typified by the 1AESS and 5AESS electronic switching systems manufactured by American Telephone & Telegraph (AT&T) Corporation. See, for example, U.S. Pat. No. 3,826,876 to Gueldenphenning et al, issued Jul. 30, 1974; U.S. Pat. No. 4,232,199 to Boatwright et al, issued Nov. 4, 1980; U.S. Pat. No. 4,720,848 to Akiyama, issued Jan. 19, 1988; and U.S. Pat. No. 4,878,240 to Lin et al, issued Oct. 31, 1989.

A need has been identified for a service which will provide to residential customers a control over their telephone service to permit work or relaxation without the normal interruptions caused by a ringing telephone. Such a service must be easy to use, economically priced, and must provide courteous handling of incoming calls.

### SUMMARY OF THE INVENTION

The present invention provides a do-not-disturb (DND) device which can be easily inserted between a telephone line carrying an incoming telephone signal and a called telephone for which the incoming telephone signal is intended. A terminating telephone system switch associated with the called telephone senses the presence of the DND device and sends the incoming telephone signal to a voicemail system. The DND device being active may cause the called telephone to assume a busy condition such as simulating an off hook impedance, thereby making the called telephone appear busy to a calling telephone system. The DND device may also reset a voicemail system to receive calls upon zero rings to the called telephone, thereby routing the incoming call to voicemail or a call forwarding number prior to ringing the called telephone. The DND device may also reset an answering machine to zero rings to answer an incoming call prior to ringing the telephone. The DND device may also suppress ringing by detecting incoming calls and suppressing ringing while handling the call. The present invention also provides a telephone system, comprising a telephone network (switch) for sending a telephone signal to a called telephone over a communication link wireline or wireless. A do-not-disturb device is interposed between the telephone and the switch, wherein the do-not-disturb device is adapted to be set at a first position and a second position, and wherein the switch sends the telephone signal to a location other than the telephone associated with the DND device when the DND device is set at the first position.

The telephone system may comprise a communication link such as a member that links the switch to a called telephone, and a wireless link. The DND device allows the telephone signal to reach the called telephone when the DND device is set at the second position and prevents the telephone signal from reaching the selected telephone when the DND device is set at the first position. The switch sends the telephone signal to a voice mail service when the DND device is set at the first position. The DND device includes a visual indication that turns on when the DND device is set at the first position and a timer that when set for a selected time period causes the DND device to automatically set to the second position upon the expiration of the selected time period. The DND device can also be integrated into a wire line or wireless telephone.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE FIGURES

For detailed understanding of the present invention, references should be made to the following detailed description of an exemplary embodiment, taken in conjunction with the accompanying drawings, in which like elements have been given like numerals.

FIG. 1 illustrates an example of a high level architectural diagram of the environment in which the Do-Not-Disturb (DND) device operates in the present example of the invention operates;

FIG. 2 illustrates more of the details of the DND device;

FIG. 3 illustrates functions performed in an example of the present invention when a Do Not Disturb button is pressed in the present example of the invention;

FIG. 4 illustrates functions performed in an example of the present invention for setting an incoming call ring count to zero for a voicemail system in the present example of the invention

FIG. 5 illustrates functions performed in an example of the present invention for sending an incoming call to an answering machine in the present example of the invention;

FIG. 6 illustrates functions performed in an example of the present invention for sending an incoming call to a call forwarding number in the present example of the invention;

FIG. 7 illustrates functions performed in an example of the present invention for setting a called telephone to a busy condition such as an off hook impedance to send an incoming call to a voicemail immediately, answering machine or call forwarding number in the present example of the invention; and

FIG. 8 illustrates functions performed in an example of the present invention for setting a called telephone to suppress ringing while a telephone handles an incoming call to or a DND device sends an incoming call to a voicemail, answering machine or call forwarding number in the present example of the invention.

### DETAILED DESCRIPTION OF THE EXEMPLARY EMBODIMENTS

In view of the above, the present invention through one or more of its various aspects and/or embodiments is presented to accomplish one or more advantages, such as those noted below.

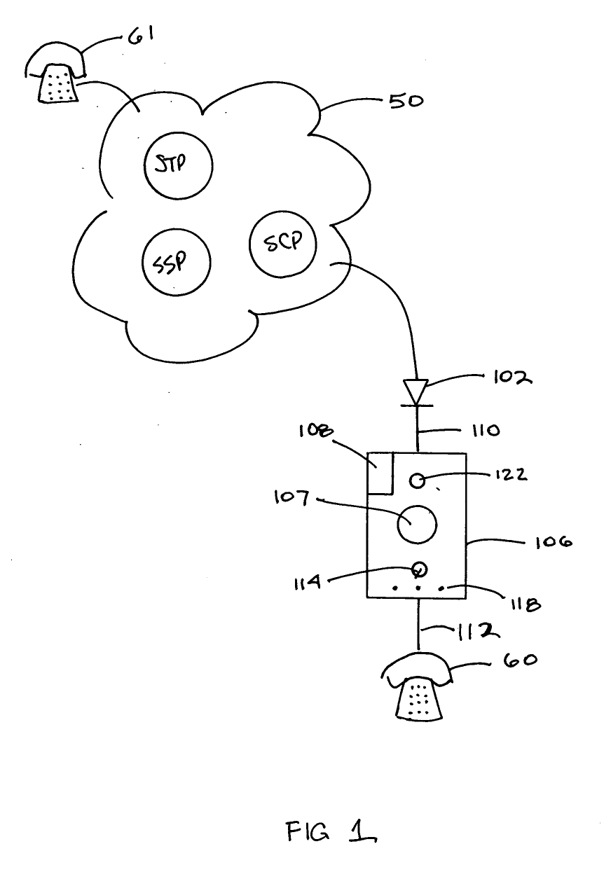

Turning now to FIG. 1, a customer telephone 60 and caller telephone 61 are shown associated with the PSTN 50 of the architectural schematic of FIG. 1. The PSTN comprises at least one Signal Transfer Point (STP), Signal Service Point (SSP) and Service Control Point (SCP) and a database component, which are well known in the art. In the current example the customer is also a voicemail subscriber. The voicemail system is provided by the SCP. The voicemail system is configured by calling into the voicemail system from the subscriber telephone 60. Part of the configuration for the voicemail system is to set a ring count at which the voicemail system takes over an incoming call to the telephone. The voicemail system could also be implemented in a unified messaging service (UMS) platform or a voice over internet protocol (VoIP) telephone system, both of which are well known in the art.

The telephone system associated with the caller telephone 61 sends an incoming call to the subscriber telephone 60. The call travels through one or more PSTNs, UMS platforms or VoIP telephone systems and terminates at a switch associated with a wall jack 102 associated with the subscriber telephone 60. A phone line 112 normally connects the subscriber telephone to the wall jack for standard telephone operations, including voicemail, call forwarding and a variety of other public telephone services. In the present example of the invention, the telephone line 112 is interrupted and a do not disturb (DND) device 104 is inserted between the subscriber telephone and the wall jack 102. An additional length of standard telephone line 110 is used to connect the DND device to the wall jack. The standard telephone line 112 connects the DND device to the subscriber telephone.

When the DND button 107 is pressed to make the DND device 106 active, incoming calls from telephones such as caller telephone 61 are handled so that the people associated with the subscriber telephone 60 associated with the DND device are not bothered by a ringing telephone. A DND light 122 is lit and set to intermittent blinking when the DND device is in an active state. The light 122 is not lit when the DND device is not active. A DND timer switch 114 is provided to allow the subscriber to determine the duration of the DND active state, which can be set for example to 1 hour, 8 hours or to an indefinite period by selecting one of three timer positions 118 by rotating timer switch 114 to align with one of the three timer positions. Electronics 108 controls and executes the functions of the DND function provided in the DND device.

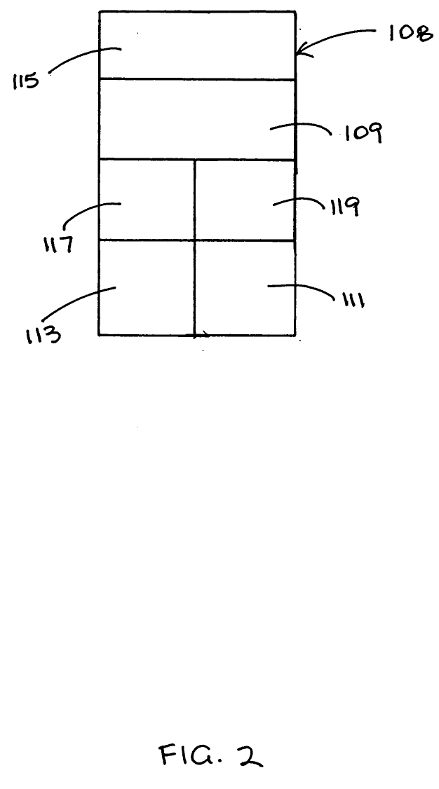

Turning now to FIG. 2, the DND device electronics 108 are shown in more detail. The DND device electronics 108 include an input output device 115 for communicating with the PSTN, UMS or VoIP telephone system at which the voicemail or call forwarding service for the subscriber telephone exists. The DND device further includes a microprocessor with memory 109, a power supply 117 such as a battery, a ring suppression circuit 113 and an off hook busy circuit 111. The ring suppression circuit and busy circuits are well known in the art and are now shown for simplicity. The busy condition circuit is well known in the art and for example may be an impedance equivalent to an off hook telephone or an impedance equivalent to a telephone engaged in call or logged onto the Internet.

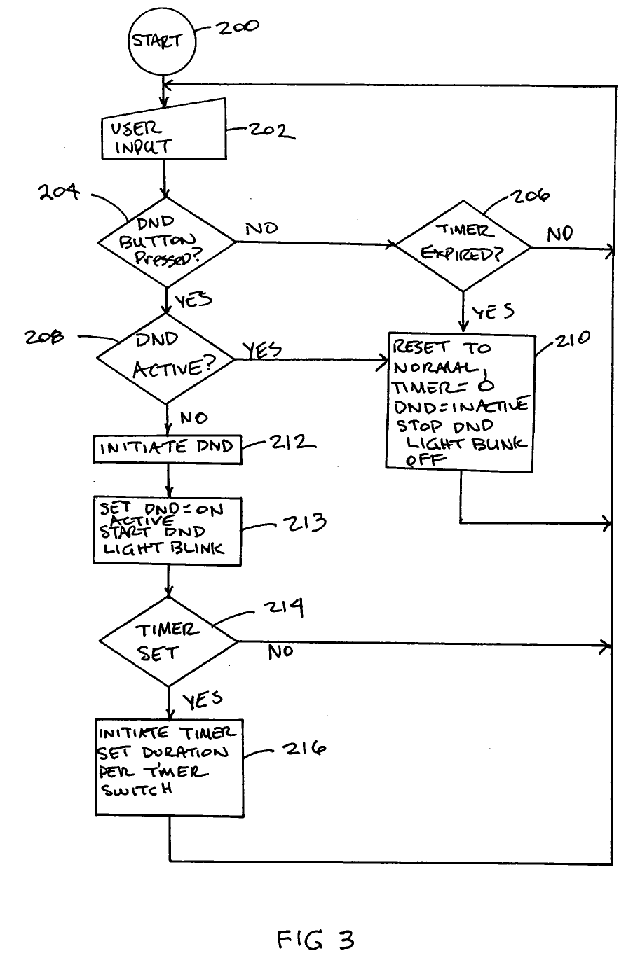

Turning now to FIG. 3, an example of the functions performed in the DND device is illustrated. Starting at entry point 200 after execution of a power on reset boot routine, the DND function of the present invention proceeds to check for user input 202 to determine at 204 if the DND button 107 has been pressed. If the DND button has not been pressed the DND function checks to see if the DND timer has expired at block 206. If the timer has not expired, the DND function returns to check for user input again at 202. If the DND timer has expired the DND function proceeds to block 210 to reset the telephone to allow calls to pass through normally, reset and deactivate DND functions, reset the DND timer to zero, set a DND variable in processor memory to “inactive” and turn off the DND light 122.

If the DND button is pressed at 204, the DND function proceeds to determine if the DND status variable in processor memory is set to “active.” If the DND status variable in processor memory is set to “active,” the pressing of the DND button is intended to deactivate the DND function and thus, the DND function proceeds to block 210, discussed above, to deactivate the DND function. The DND function then returns to check for user input at 202. If the DND button is pressed at 204 and the DND status variable in processor memory set to “inactive,” then the pressing of the DND button is meant to activate the DND function and thus, the DND function proceeds to block 212 to activate the DND function.

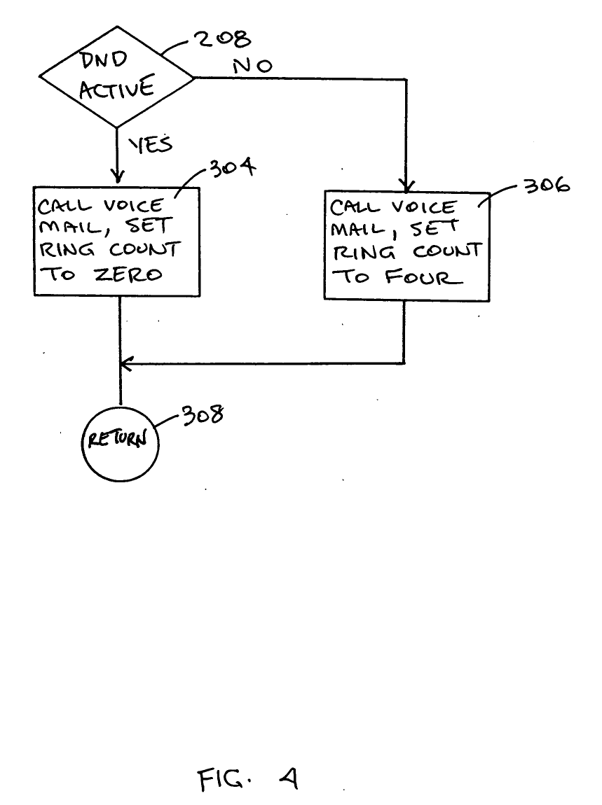

At block 212 the DND function initiates the DND function and sets the DND status variable in processor memory to “active”. There are several modes of DND functionality which are initiated in block 212 some of which are illustrated in FIGS. 4-8. The DND mode is programmed into the DND device or can be selected by setting a switch in the DND device to select the mode of operation.

The DND function then proceeds to intermittently light the DND light at block 213 to indicate that the DND device is active. At block 214 the DND function checks to determine at which position the timer is set 1 hour, 8 hours, or indefinite. At block 216 the timer is initiated by setting a timer active variable in processor memory to “timer active” and a timer expired variable in processor memory to “not expired.” The processor decrements the timer using a system clock associated with the processor. Once the timer is expired after the preset time, the processor sets the DND timer expired variable in processor memory to “expired.” If the timer is set to the indefinite position, the DND function is active until the DND button is pressed again to turn off the DND function. In this case the processor sets the DND timer active variable in processor memory to “timer not active.” If the timer is set to the 1-hour position the DND function is active until the timer expires in 1 hour. In this case the processor sets the timer active variable in processor memory to “timer active” and sets the timer for 1 hour. If the timer is set to the 8-hour position the DND function is active until the timer expires in 8 hours. In this case the processor sets the timer active variable in processor memory to “timer active” and sets the timer for 8 hours.

Turning now to FIG. 4, one of the initiate DND modes from FIG. 3 block 212 is illustrated. In the example of FIG. 4 the DND function is configured in the processor to send incoming calls to voicemail without ringing the voicemail subscriber telephone 60. If the DND variable in processor memory is set to “active” at block 302, then in the present example of the invention the DND function proceeds to block 304 where the DND function uses the processor and processor memory 109 and input output device 115 to call the voice mail system and set the ring count to zero. This is done by emulating the user input to the voicemail system from the subscriber telephone, in which the subscriber calls the voicemail system and through input from the telephone sets the voicemail ring count to zero. Thus, upon pressing the DND button, incoming calls are routed to voice mail without ringing the subscriber telephone 60. Ring suppression can also be enabled if desired to ensure that the voicemail system does not allow a ring to the subscriber telephone prior to taking over the call at the voicemail system. If the DND variable in processor memory is set to “inactive” at block 302, then in the present example of the invention the DND function proceeds to block 306 where the DND function uses the processor and processor memory 109 and input output device 115 to call the voice mail service and set the ring count to 4. This is done by emulating the user input from the subscriber telephone in which the subscriber calls the voice mail service and through input from the telephone, sets the voicemail ring count to 4. Thus, incoming calls are routed to voice mail after 4 rings of the subscriber telephone 60. Calls can be answered normally during the 4 rings prior to going to voicemail in this mode. In the present example of the invention, the processor can be preprogrammed to call the voicemail service to set the ring count or can be set to a learn mode to learn or monitor and store in memory the sequence of operations to call and set the ring count while a user goes through the process of calling the voicemail service and setting the ring count to zero and to normal ring count, e.g. 4 rings. The sequence of operations is monitored by the processor during the learning mode and stored in memory from which the sequence of operations is played back to set the ring count to zero or 4 or another number rings previously programmed into the voicemail system. The voice mail system or call forwarding system may also be conditioned to receive a special DND code from the DND device which sets the ring count to zero for implementation of the DND service.

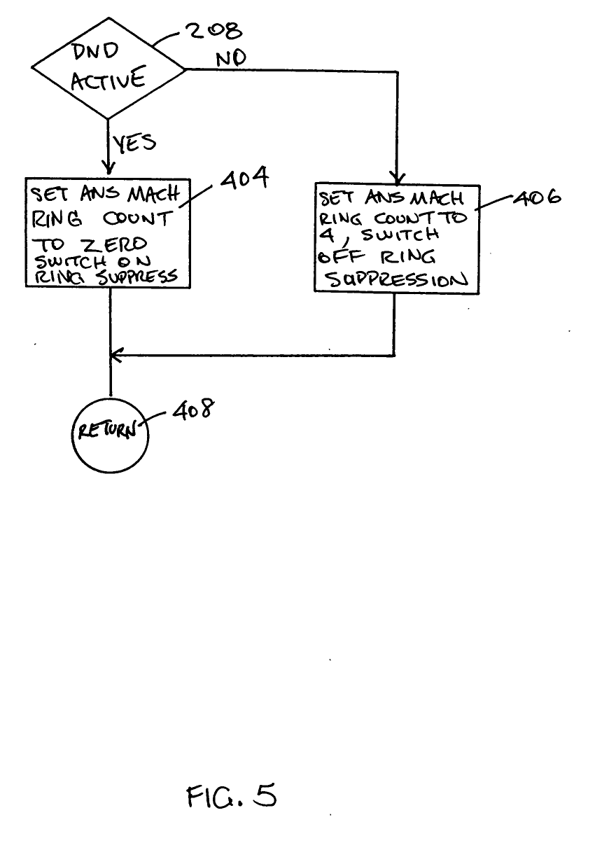

Turning now to FIG. 5, another one of the initiate DND modes from FIG. 3 block 212 modes is illustrated. In this case the DND function is configured in the processor to send incoming calls to an answering machine without ringing the subscriber telephone 60. If the DND variable in processor memory is set to “active” at block 208, then in the present example of the invention the DND function proceeds to block 404 where the DND function uses the processor and processor memory 109 and input output device 115 to call the answering machine and set the ring count to zero. This is done by emulating the user input from the subscriber telephone in which the subscriber calls the answering machine and through input from the telephone sets the answering machine ring count to zero. Thus, incoming calls are routed to the answering without ringing the subscriber telephone 60. Ring suppression can be turned on so that the ring suppression circuitry 113 suppresses ringing of the telephone in addition to setting a ring count to zero for a voicemail system, call forwarding system or an answering machine. If the DND variable in processor memory is set to “inactive” at block 208, then in the present example of the invention the DND function proceeds to block 406 where the DND function uses the processor and processor memory 109 and input output device 115 to call the answering machine and set the ring count to 4. Ring suppression is turned off upon DND deactivation so that the subscriber telephone rings normally. This is done by emulating the user input from the subscriber telephone in which the subscriber calls the answering machine and through input from the telephone sets the voicemail ring count to 4. In the present example of the invention, the processor can be programmed to call the answering machine or can be set to a learn mode to learn the sequence of operations while a user goes through the process of calling the answering machine and setting the ring count to zero. Thus, incoming calls are routed to the answering machine after 4 rings of the subscriber telephone 60. Calls can be answered normally during the 4 rings prior to going to the answering machine in this mode.

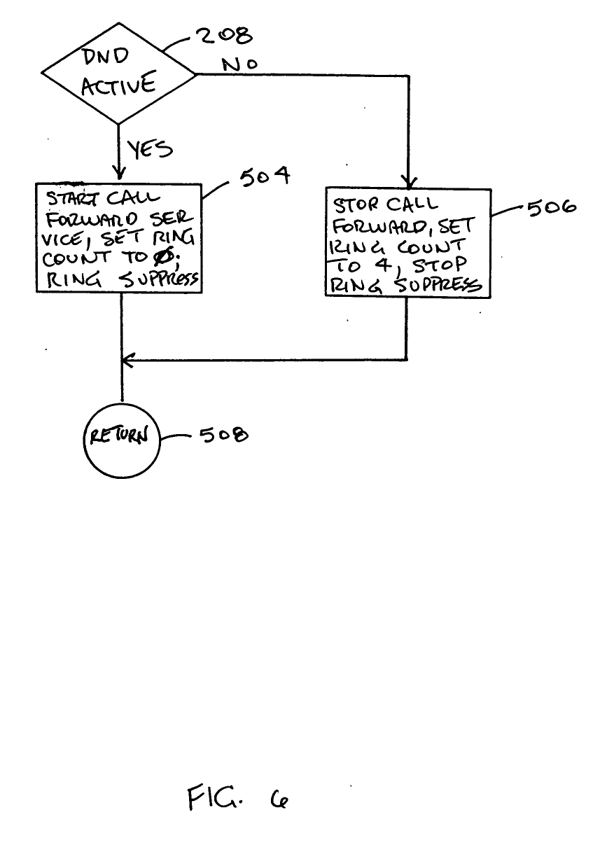

Turning now to FIG. 6, another one of the initiate DND modes from FIG. 3 block 212 is illustrated. In this case the DND function is configured in the processor to send incoming calls to a call forwarding service without causing the subscriber telephone 60 to ring. If the DND variable in processor memory is set to “active” at block 208, then in the present example of the invention the DND function proceeds to block 504 where the DND function uses the processor and processor memory 109 and input output device 115 to call the call forwarding service and set the ring count to zero. Ring suppression can be turned on so that the ring suppression circuitry 113 suppresses ringing of the telephone during call forwarding. This is done by emulating the user input from the subscriber telephone in which the subscriber calls the call forwarding service and through input from the telephone sets the call forwarding service ring count to zero. Thus, incoming calls are routed to the answering without ringing the subscriber telephone 60. If the DND variable in processor memory is set to “inactive” at block 208, then in the present example of the invention the DND function proceeds to block 506 where the DND function uses the processor and processor memory 109 and input output device 115 to call the call forwarding service and set the ring count to 4. Ring suppression is then turned off so that the subscriber telephone rings normally. This is done by emulating the user input from the subscriber telephone in which the subscriber calls the call forwarding service and through input from the telephone sets the voicemail ring count to 4. Thus, incoming calls are routed to the call forwarding service after 4 rings of the subscriber telephone 60. Calls can be answered normally during the 4 rings prior to going to the call forwarding service in this mode. In the present example of the invention, the processor can be programmed to call the call forwarding service or can be set to a learn mode to learn the sequence of operations while a user goes through the process of calling the call forwarding service and setting the ring count to zero.

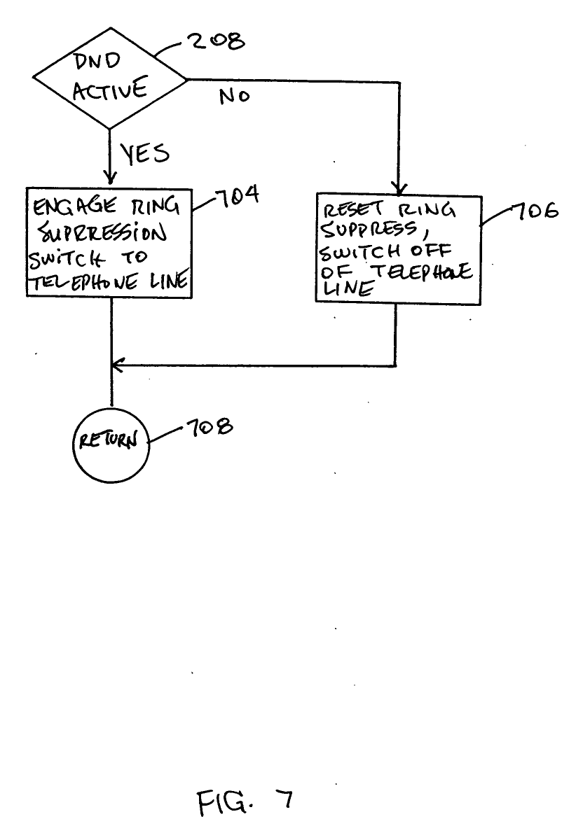

Turning now to FIG. 7, one of the initiate DND from FIG. 3 block 212 modes is illustrated. In this case the DND function is configured in the processor to receive incoming calls without ringing the subscriber telephone 60. If the DND variable in processor memory is set to “active” at block 208, then in the present example of the invention the DND function proceeds to block 704 where the DND function uses the processor and processor memory 109 and a switch 119 to switch the input telephone line from the subscriber telephone to an ring detection and suppression circuit 113 so that incoming calls do not cause the telephone to ring. Calls are forwarded in their normal course of rings, according to the ring count for voicemail, answering machine or call forwarding without disturbing the subscriber associated with subscriber telephone 60. Thus, incoming calls are routed without ringing the subscriber telephone 60. If the DND variable in processor memory is set to “inactive” at block 208, then in the present example of the invention the DND function proceeds to block 706 where the DND function uses the processor and processor memory 109 to switch the input line from the call detection and ring suppression circuitry 113 back to the subscriber telephone. Incoming calls then cause the subscriber telephone to ring normally and calls can then be answered normally.

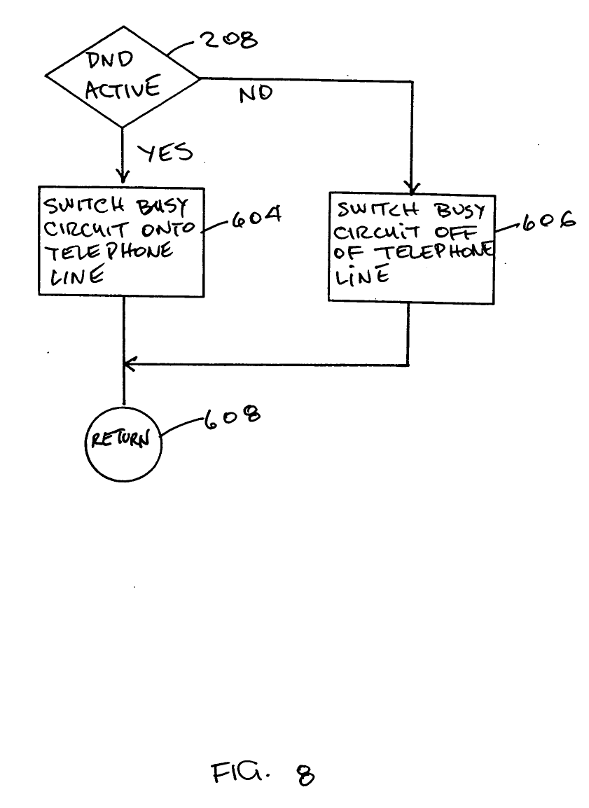

Turning now to FIG. 8, one of the initiate DND from FIG. 3 block 212 modes is illustrated. In this case the DND function is configured in the processor to send incoming calls to an answering machine without ringing the subscriber telephone 60. If the DND variable in processor memory is set to “active” at block 208, then in the present example of the invention the DND function proceeds to block 604 where the DND function uses the processor and processor memory 109 switch the input telephone line from the subscriber telephone to a busy condition such as an equivalent off hook impedance so that incoming call are forwarded immediately to voicemail. The telephone system providing the incoming call to the wall jack sees a busy condition such as an off hook impedance and treats the subscriber phone as though the subscriber phone is busy on another call or off the hook. Thus, incoming calls see a busy condition and are not answered or are routed to voicemail without ringing the subscriber telephone 60. If the DND variable in processor memory is set to “inactive” at block 208, then in the present example of the invention the DND function proceeds to block 806 where the DND function uses the processor and processor memory 109 to switch the input line from the off hook impedance back to the subscriber telephone. Incoming calls then ring the subscriber telephone and calls can be answered normally.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a computer readable medium, a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission and public telephone networks represent examples of the state of the art. Such standards are periodically superseded by faster or more efficient equivalents having essentially the same functions. Accordingly, replacement standards and protocols having the same functions are considered equivalents.

What is claimed is:

1. A method of providing a Do-Not-Disturb (DND) telephone service associated with a telephone, comprising:
sending a telephone signal to the telephone;
determining if a DND device associated with the telephone is active; and
sending the telephone signal to a device other than the telephone if the DND device is active.

2. The method of claim 1, wherein a switch associated with the telephone signal determines whether the DND device is active.

3. The method of claim 1, wherein sending the telephone signal to a device other than the telephone includes sending the telephone signal to a voicemail system.

4. The method of claim 3, further comprising:
setting the voicemail system to receive calls upon zero rings to the telephone when the DND device is active.

5. The method of claim 1, further comprising:
wherein sending the telephone signal to a device other than the telephone includes sending the telephone signal to a call forwarding system.

6. The method of claim 5, further comprising:
setting the call forwarding system to receive calls upon zero rings to the telephone when the DND device is active.

7. The method of claim 1, further comprising:
determining if a DND timer has expired and resetting the DND device associated with the telephone to inactive if the DND timer has expired.

8. The method of claim 1, further comprising:
activating a DND indicator light when the DND device is active.

9. The method of claim 1, wherein sending the telephone signal to a device other than the telephone includes switching the telephone signal to a telephone busy circuit associated with the DND device when the DND device is active.

10. The method of claim 1, further comprising:
wherein sending the telephone signal to a device other than the telephone includes switching the telephone signal to a ring suppression circuit associated with the DND device when the DND device is active.

11. A telephone system for providing a Do-Not-Disturb (DND) service to a telephone, comprising:
a telephone switch for sending a telephone signal to the telephone over a communication link; and
a DND device interposed between the telephone and a switch associated with the telephone signal, said DND device adapted to be set at a first position and a second position, wherein the switch sends the telephone signal to a location other than the telephone when said DND device is set at the first position.

12. The telephone system of claim 11 wherein the communication link is one of a member that links the switch to the telephone and a wireless link.

13. The telephone system of claim 11 wherein the DND device allows the telephone signal to reach the telephone when the DND device is set at the second position and prevents the telephone signal from reaching the telephone when the DND device is set at the first position.

14. The telephone system of claim 11 wherein the switch sends the telephone signal to a voicemail system when the DND device is set at the first position.

15. The telephone system of claim 11 wherein the DND device includes a visual indication that turns on when the DND device is set at the first position.

16. The telephone system of claim 11 wherein the DND device includes a timer that when set for a selected time period causes the DND device to automatically reset to the second position upon the expiration of said selected time period.

17. The telephone system of claim 11 wherein the DND device is integrated into the telephone.

18. The telephone system of claim 11 wherein the DND device when set in the first position sends one of a busy signal to the switch, and a signal that sets number of ring tones for the telephone to zero.

19. The system of claim 12 wherein the member is one of a conductor of electrical signals, and a fiber optic cable.

20. A Do-Not-Disturb (DND) device adapted for use between a telephone and a telephone network sending telephone signals to the telephone, said device comprising:
a first set position and a second set position, said device when set in the first set position causing the telephone network to send the telephone signals to a location other than the telephone.

21. The DND device of claim 20 further comprising a timer that is adapted to be set for a time period for which said DND device is to remain set in the first position.

22. The DND device of claim 20 wherein the DND device includes a visual indicator that turns on when the DND device is set in the first position.

23. The DND device of claim 20 wherein the DND device when set in the first position sends one of a busy signal to the telephone network, and a signal that sets ring count for the telephone to zero.

24. The DND device of claim 20 wherein the DND device when set in the first position forwards the telephone signal to a call forwarding location.

25. The DND device of claim 20 wherein the DND device when set in the first position switches a ring suppression circuit in place of the telephone.

26. The DND device of claim 20 wherein the DND device when set in the first position switches a telephone busy circuit in place of the telephone.
